(19) United States
(12) Patent Application Publication
(10) Pub. No.: US 2025/0256755 A1
(43) Pub. Date: Aug. 14, 2025

(54) JUVENILE WHEELED GOOD WITH BAG HOLDER

(71) Applicant: Evenflo Company, Inc., Miamisburg, OH (US)

(72) Inventor: Jeremy CROSSGROVE, Revere, MA (US)

(21) Appl. No.: 18/439,930

(22) Filed: Feb. 13, 2024

(51) Int. Cl. B62B 9/26; B62B 7/04

(52) U.S. Cl. CPC B62B 9/26; B62B 7/04

(57) ABSTRACT

This description is related to a juvenile wheeled good system, such as a stroller or wagon, and components thereof that provide improved capabilities for providing hands-free convenience to the user. The system includes a container, such as a drink holder, removably coupled to a bag holder that can be used to hold pet waste disposal bags while using the system. The bag holder can be removed from the container (e.g., cup holder) to insert the roll of waste disposal bags and then recoupled to the container to keep the bags secure while walking the stroller. The waste disposal bags may be used for pet waste or may be used for other waste, including diapers.

### BACKGROUND

Juvenile wheeled goods can be used to transport various types of infants, toddlers, and/or child carriers and accessories. In some instances, the person using the wheeled good is also walking a pet and may need to carry pet waste removal bags. Historically, pet owners have used different techniques for transporting waste bags, such as attaching them to the pet's leash or keeping the bags in their own pockets. However, these methods frequently lack the desired level of convenience and hands-free accessibility.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numbers designate corresponding parts throughout different views.

FIG. 1 is a perspective view of a stroller with a container and a bag holder in accordance with a first embodiment of the present invention.

FIG. 2 is a perspective view of the stroller shown in FIG. 1 with the container and the bag holder removed to show it is removably coupled.

FIGS. 3A-3C are different perspective views of the bag holder shown in FIG. 1.

FIG. 4 is a perspective view of a roll of bags and the bag holder shown in FIG. 3.

FIGS. 5A-5C are perspective views of the container shown in FIG. 1.

### DETAILED DESCRIPTION

In general, aspects described herein are related to a waste bag holder, a multi-functional container capable of including a waste bag holder, and juvenile wheeled good systems (e.g., child carrier) with a frame suitable for securing and transporting a holder for waste disposal bags (e.g., a bag holder), among other things. Transporting young children and pets at the same time can be a multi-tasking challenge, and carrying a roll of waste disposal bags adds an extra layer of complexity. Traditionally, pet owners have employed various methods to carry these bags. While options include attaching individual bags to the pet's leash, carrying them in the owner's pockets, or utilizing a stroller compartment (e.g., the storage space under the stroller), these approaches often fall short in terms of convenience and hands-free accessibility. This disclosure is related to a juvenile wheeled good, such as a stroller or wagon, and components thereof that provide improved capabilities for housing a roll of waste disposal bags. For example, some aspects of the disclosure provide improved access to waste disposal bags by having a bag holder that is removably coupled to a container, such as a cup holder, that is attached to the wheeled good. Many juvenile wheeled goods are already equipped to receive a cup holder or similar removable container such that the addition of a bag holder to the cup holder has minimal to no cost and/or time increase on production of the juvenile wheeled good itself. Additionally, placement of the bag holder with the other container, such as a cup holder, will place the bag holder in an easily accessible location.

The bag holder can be removed from the container (e.g., cup holder) if it is no longer needed and the container can still be utilized. Additionally, the bag holder can be removed from the container (e.g., cup holder) to insert the roll of waste disposal bags and can then be recoupled to the container to keep the bags secure while a user is walking the juvenile wheeled good. The waste disposal bags may be used for pet waste or may be used for other waste, including diapers.

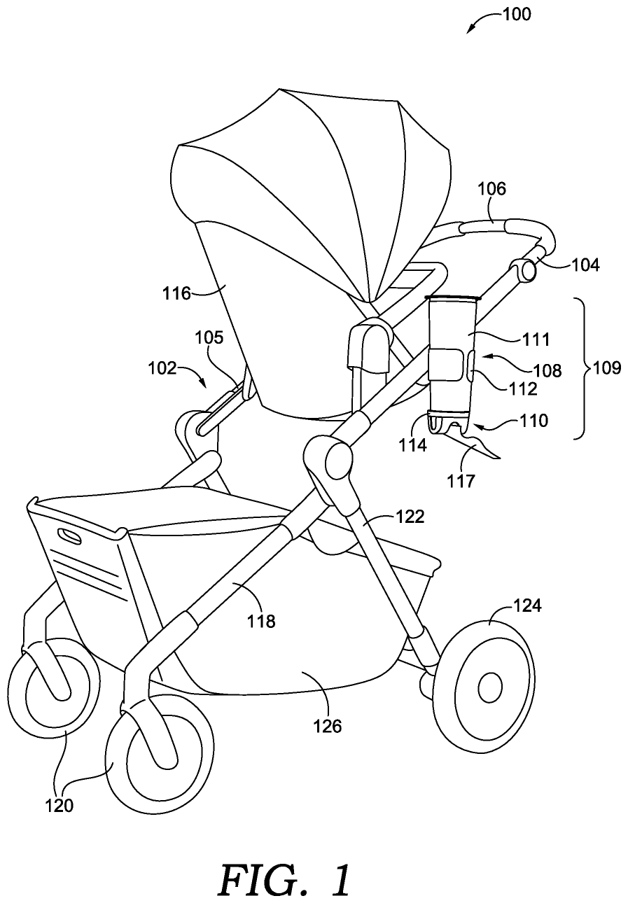

With reference now to FIG. 1, a juvenile wheeled good system 100 is provided. In aspects, the juvenile wheeled good 100 could be a stroller or a wagon. For example, in FIG. 1, the juvenile wheeled good 100 is a stroller. The juvenile wheeled good system 100 has a frame 102 coupled to one or more wheels (e.g., 120 and 124). In the embodiment of FIG. 1, the frame 102 has an upper structure including a first rail 104 and a second rail 105 with a handlebar 106 extending between the first rail 104 and the second rail 105.

The first rail 104 and the second rail 105 connect to the frame's 102 lower structure, which includes front legs 118 and rear legs 122. At the end of each front leg 118 is a front wheel 120. The front wheels 120 may be attached via a caster, allowing the front wheels 120 to change their orientation around a vertical axis when the juvenile wheeled good system 100 is steered to one direction or another. Additionally, although the juvenile wheeled good system 100 includes two front legs 118, aspects of this disclosure may apply to strollers with a single front leg, such as jogger strollers. At the end of each rear leg 122 is a rear wheel 124, which may have a fixed orientation, with an axle connecting the two rear wheels 124 together. The axle may also include a brake to releasably lock the rear wheels 124 in order to prevent the juvenile wheeled good system 100 from moving inadvertently.

The first rail 104 and the second rail 105 include connection points for attaching and supporting a juvenile seat 116 between them. The first rail 104 and the second rail 105 also include connection points under the juvenile seat 116 for attaching and supporting a basket 126 between them. In other examples, the term “basket” may refer to other enclosures on a wheeled child carrier, including a wagon enclosure suitable for containing a child for transportation.

The frame 102 also has a multi-functional container 109 that includes a first container 108 coupled to a bag holder 110. In some aspects, the first container 108 could be a cup or beverage holder configured to hold a cup, such as cup 111. As such, the first container 108 here may also be referred to as a cup holder 108, but in other examples, the first container 108 may be a treat holder, a snack holder, or a general holder configured to carry a variety of items such as a cell phone, car keys, a wallet, and the like. In alternative embodiments, the first container 108 could be a snack holder comprising two plastic parts (e.g., a top part and a bottom part). In this example, the top part can hold treats or snacks and the bottom part can be configured to hold water. The top part can nest into or screw onto the bottom part when not in use and is configured to couple to the rail (e.g., 104). Further, the bag holder 110 may be configured to hold waste bags 117 and be easily accessible to a user as it may be, indirectly, on a side rail (e.g., first rail 104) at a location that is within arm's reach of the handlebar 106.

It is to be understood by one of skill in the art that the present invention may be suitable for use with many different types of wheeled child carriers, including different types of strollers and wagons, which may have some differences with respect to specific features than those depicted and described herein. For example, additional accessories (e.g., cup holders, pockets, etc.) may also be included on the carrier body or seat without interfering with the present invention. Furthermore, while the juvenile wheeled good system 100 shown in FIG. 1 shows the juvenile seat 116 being oriented to face towards the front of the juvenile wheeled good system 100 (and away from the handlebar 106, it is to be appreciated that the present invention may also readily be used with a juvenile wheeled good system 100 where the juvenile seat 116 is facing toward the back of the juvenile wheeled good system 100, or where the juvenile wheeled good system 100 has a bassinet or reclined seat. The present invention may also be used with other types of wheeled child carrier, such as wagons, or other movable apparatuses with enclosures, such as handcarts or trolleys.

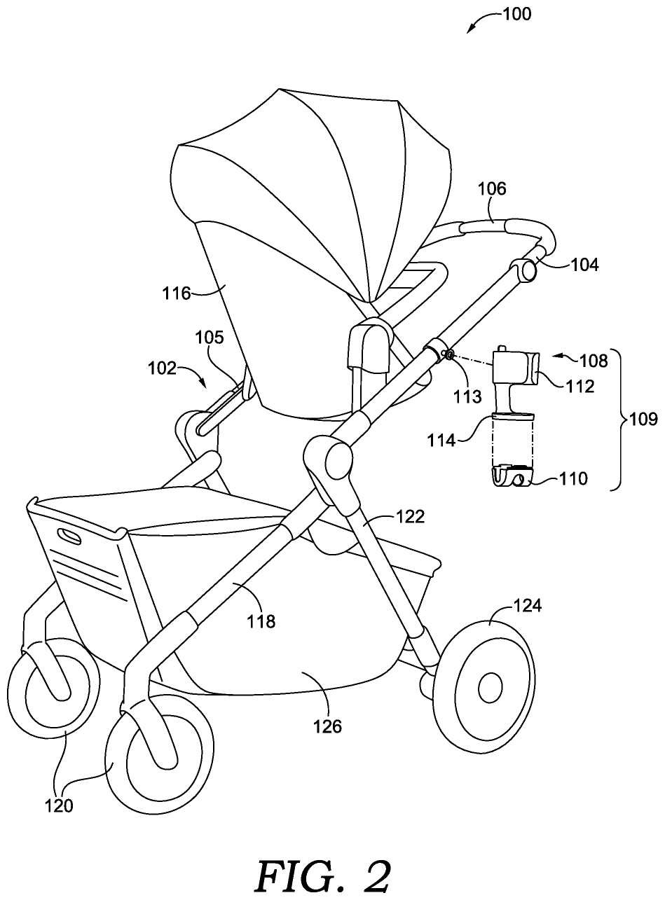

Turning to FIG. 2, examples of the multi-functional container 109 may be removable from the frame 102 of the juvenile wheeled good system 100. The cup holder 108 is configured to removably couple to the first rail 104 and/or the second rail 105. In aspects, the first rail 104 and/or the second rail 105 may comprise a coupling element 113 configured to couple to the cup holder 108 or another object. For illustration purposes, this discussion will focus on the first rail 104 having the coupling element 113, but it should be understood that in other embodiments, the second rail 105 (in addition to or alternatively to the first rail 104) may have similar structures capable of coupling to the cup holder 108. For example, in some examples, each rail has a coupling element 113 so that the user can choose which side to couple the cup holder, or could have a different cup holder or other container on either rail (i.e., the first rail 104 and/or the second rail 105).

The bag holder 110 can removably couple to a surface (e.g., bottom wall 114 or side wall 112) of the cup holder 108 as further described herein. The bag holder 110 may be removable from the cup holder 108 so that the bag holder 100 may be re-filled with new waste bags 117. Additionally, the bag holder 110 may be removable from the cup holder 108 so that the cup holder 108 may be used as a standalone cup holder 108 without the bag holder 110.

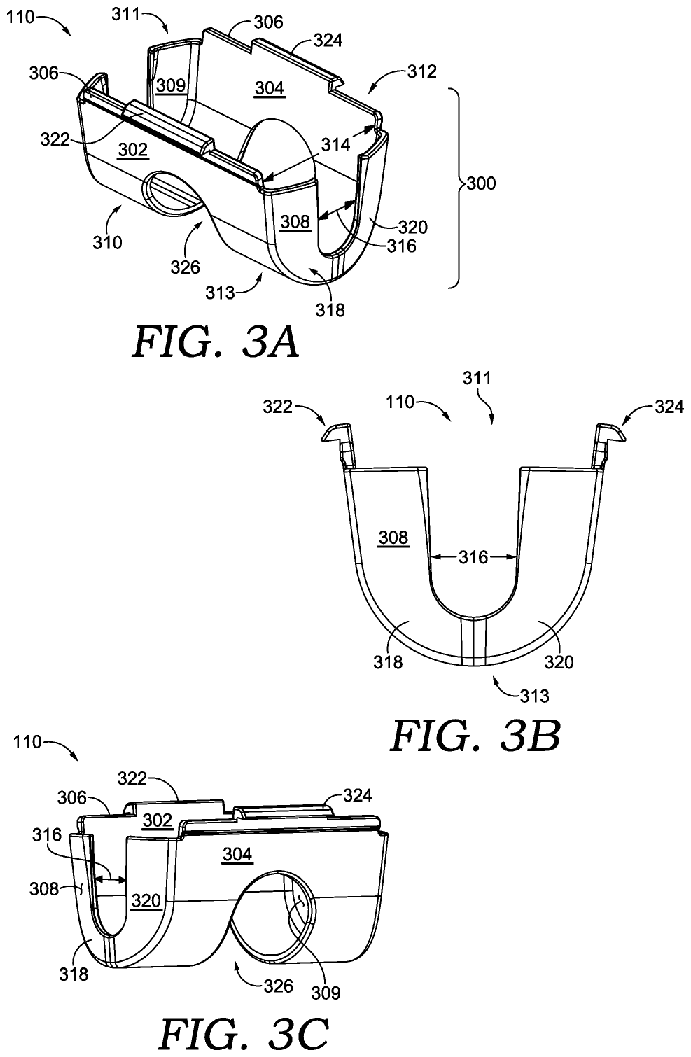

FIGS. 3A-3C provide various perspective views of the bag holder 110. The bag holder 110 comprises a first structure, referred to herein as a body 300, having a first side wall 302 at a first side 310 and a second side wall 304 at a second side 312. The first side wall 302 and the second side wall 304 each extend from a third side 311 to a fourth side 313. In the embodiment shown in FIGS. 1 and 2, the third side 311 and the fourth side 313 may generally correspond to a top side and a bottom side, respectively, when the bag holder 110 is coupled to the cup holder 108. The first side wall 302 and the second side wall 304 each define an edge 306 facing towards the third side 311, where the edges 306 of the first side wall 302 and the second side wall 304 are spaced apart. The first side wall 302 and the second side wall 304 may be joined on the fourth side 313. In this way, the first side wall 302 and the second side wall 304 may form a generally U-shaped configuration. The body 300 of the bag holder 110 may be curved at the fourth side 313, where the curved wall on the fourth side 313 may be formed by a fourth side wall or portions of the first and second side walls 302 and 304.

The spacing 314 between the first side wall 302 and the second side wall 304 defines a void sized to hold a plurality of waste disposal bags. The spacing 314 may be within a range of about 1.0 inches to about 2.0 inches. In one example, the spacing 314 is about 1.6 inches. The body 300 of the bag holder 110 comprises an opening 326 on the fourth side 313 that is configured to hold a plurality of bags (e.g., pet waste disposal bags) and through which one or more waste disposal bags can be removed. In some aspects, while a plurality of waste disposal bags (e.g., a roll) may be held within the void of the body 300 of the bag holder 110, bags may be individually removed through the opening 326. In some examples, the bag holder 110 may also have a first end wall 308 and a second end wall 309, each extending between the first side wall 302 and the second side wall 304 on opposite ends of the body 300. The first end wall 308 and the second end wall 309 may also define the void that receives the plurality of waste bags for holding within the bag holder 110. Each of the first end wall 308 and the second end wall 309 has a first portion 318 and a second portion 320 of the first end wall 308. The first portion 318 and the second portion 320 may have a curved surface and be joined together at the fourth side 414 of the body 300 but may remain spaced apart at the third side 311. In this way, each of the first end wall 308 and the second end wall 309 may have a U-shaped configuration with a gap 316 between at least part of the first portion 318 and at least part of the second portion 320. The gap 316 may be within a range of about 0.4 inches to about 0.8 inches. In some aspects, the gap 316 increases closer to the third side 311 compared to the fourth side 313. In other aspects, the distance 316 may be uniform.

In some aspects, the material of the body 300 of the bag holder 110 is a relatively flexible material capable of flexing upon force by a user's hand. For example, the material of the body 300 could comprised of polypropylene (PP) due to its flexing properties. The benefit of using PP is that it not only allows the body 300 to be flexible but has some resiliency, enhancing the strength to increase the number of times the body 300 may be flexed over the bag holder's 110 lifespan. PP also has enough rigidity to form hooks as a coupling element as further described herein. In some examples, the body 300 comprising PP could be strategically designed with rib structures to minimize the flexing properties, and in other examples, the body 300 does not contain rib structures. In other embodiments, the material of the body 300 could comprise a mix of various plastics and polymers, including rubber. The body 300 of the bag holder 110 is configured to flex between the first portion 318 and the second portion 320 of the first and second end walls 308, 309, so that the first and second portions 318 and 320 are capable of being moved closer together. In this way, the gap 316 between the first and second portions 318 and 320 may change as further described below.

The third side 311 of the bag holder 110 is configured to couple to the cup holder 108. Particularly, the edges 306 of the first and second side walls 302 and 304 comprises coupling elements configured to removably couple the bag holder 110 to a second structure (e.g., the cup holder 108). The body 300 includes a first coupling element 322 on the edge 306 of the first side wall 302 and a second coupling element 324 on the edge 306 of the second side wall 304, both the first coupling element 322 and the second coupling element 324 each configured to couple to coupling elements on the cup holder 108. In aspects, the first coupling element 322 and the second coupling element 324 can be a hook oriented so that the hook extends away from the opposite side wall (e.g., the first coupling element 322 faces away from the second side wall 304 and the second coupling element 324 faces away from the first side wall 302), as seen in FIG. 3B. It should be noted that the various walls can be separately formed and joined together or formed together as a unitary structure.

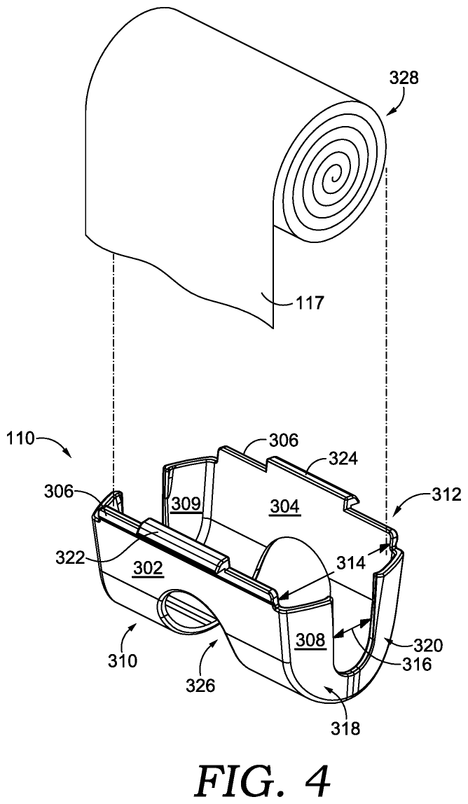

FIG. 4 shows a roll of waste disposal bags 328 to illustrate how a roll of waste disposal bags 328 fit into the bag holder 110. Once the roll of waste disposal bags 328 are placed inside the void defined by the body 300 of the bag holder 110, the bag opening 326 at the bottom of the body of the bag holder 110 is smaller than the length of the roll of waste disposal bags 328 to keep the bags secured inside the bag holder 110. At the same time, an individual bag 117 from the roll of waste disposal bags 328 may be configured to fit through the opening 326 for removal.

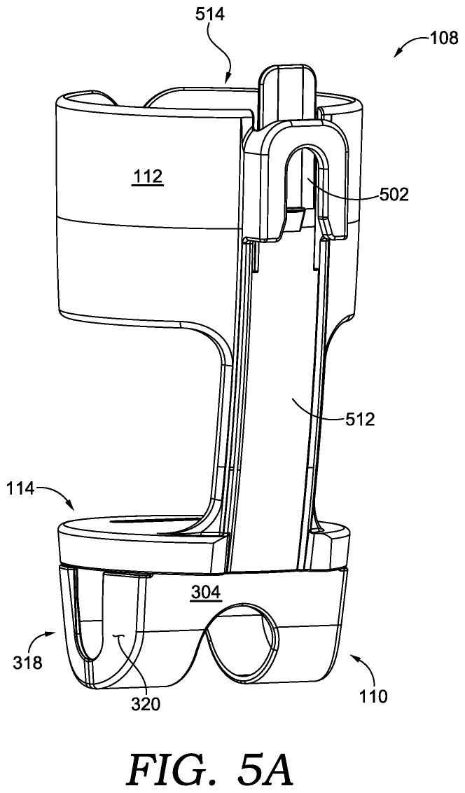

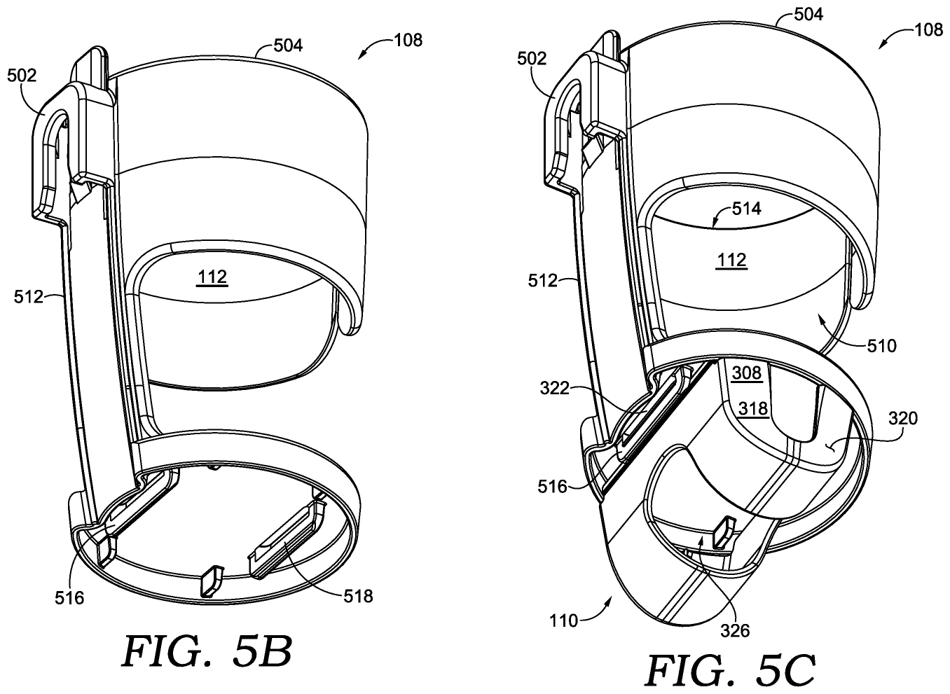

Turning now to FIGS. 5A-5C, are perspective views of the container 108 coupled with the bag holder 110 (together the multi-functional container). The container has one or more side walls 112 and a bottom wall 114, wherein the one or more side walls 112 and the bottom wall 114 define a first void 510 sized to receive a cup. The container 108 has a top side wall 504, which is part of the top portion 514 and at least partially spaced from the bottom wall 114, and a connecting side wall 512 that connects a portion of the top side wall 504 to the bottom wall 114. In some aspects, the container 108 could have a cover.

In aspects, the underside of the bottom wall 114 has a third coupling element 516 configured to be coupled with the first coupling element 322 of the bag holder 110 and a fourth coupling element 518 configured to be coupled with the second coupling element 324 of the bag holder 110. The first coupling element 322 and the second coupling element 324 define a slot for receiving the one or more coupling structures of the bag holder. In alternative embodiments, the third coupling element 516 and the fourth coupling element 518 may be on the side wall 112 or the connecting side wall 512. In other embodiments, the entire connecting side wall 512 may join the top portion 514 to the bottom wall 114. In aspects, the one or more side walls 112 of the container 108 comprise a container coupling structure 502 configured to removably couple the container 108 to the juvenile wheeled good system 100.

As shown in FIG. 5C, the first coupling element 322 (i.e., the hook on the bag holder 110) is engaged with the third coupling element 516 (i.e., the slot on the cup holder 108) when the two components are coupled together and although not visible in FIG. 5C, the second coupling element 324 may be similarly engaged with the fourth coupling element 518. A user can squeeze the first and second side walls 302 and 304 together to remove the hooks from the slots. In aspects where the body 300 comprises a flexible material (e.g., PP and/or rubber for example), the flexibility of the material and/or the gap 316 of the first portion 318 and the second portion 320 in end wall 308 may enable the body 300 to flex so that the two portions 318 and 320 can be moved together. The two portions on end wall 309 may have similar structures capable of flexing similar to the portions on end wall 308. After the hooks are disengaged from the slots, the bag holder 110 may be rejoined to the cup holder 108 in a similar fashion (e.g., flexing the two portions 318 and 320 closer together and then releasing so that the hooks are re-engaged within the slots of the cup holder 108).

Particularly, the removable aspect allows a user to replace the roll of waste disposal bags 328 in the bag holder 110, as well as allows the user the ability to utilize the cup holder 108 without the bag holder 110. Furthermore, securing the bag holder 110 at two places (i.e., 322 and 324) keeps a stable connection so that the bag holder 110 is moved with the cup holder 108 stably without swinging around.

In alternative embodiments, one side of the bag holder 110 forms a hinge with the bottom wall 114 of the container 108, wherein the bag holder 110 has only one coupling structure capable of being removably coupled to the container 108 to receive a roll and the other side (e.g., at the hinge) is permanently attached to the container 108. In alternative embodiments, the first coupling element 322 and the second coupling element 324 can each be a spring loaded pin, wherein the pin could be in either the bag holder 110 or the cup holder 108 and the opening for the pin could be in the other structure. Alternatively, the first coupling element 322 and the second coupling element 324 can slide onto the third and fourth coupling elements (not shown) by sliding on a track (such as a T-slot), or by a different latching structure. In aspects, the first coupling element 322 and the second coupling element 324 can be integrally formed within the bag holder 110 or the container 108. In these alternative embodiments, the material of the bag holder 110 could be a less flexible material than PP, such as a plastic with minimal flex.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

This above detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or implementations can become apparent to those of ordinary skill in the art to which the present subject matter pertains without departing from the scope hereof.

What is claimed is:

1. A juvenile wheeled good system comprising:
a juvenile wheeled good comprising a frame coupled to one or more wheels;
a container configured to be removably coupled to the frame; and
a bag holder configured to be removably coupled to a surface of the container.

2. The juvenile wheeled good of claim 1, wherein the juvenile wheeled good is a stroller.

3. The juvenile wheeled good system of claim 1, wherein the frame is a wagon.

4. The juvenile wheeled good system of claim 1, wherein the container is a cup holder.

5. The juvenile wheeled good system of claim 1, wherein the bag holder is sized to receive a roll of waste disposal bags.

6. The juvenile wheeled good system of claim 5, further comprising a bag opening at a bottom side of the bag holder through which one or more waste disposal bags are removed from a void while the bag holder is coupled to the surface of the container, the bag opening being smaller than the roll of waste disposal bags.

7. A multi-functional container comprising:
a first container having a bottom wall and one or more side walls, the bottom wall and the one or more side walls defining a first void; and
a bag holder having a second void configured to hold a plurality of bags and having one or more coupling structures configured to removably couple the bag holder to the first container at one or more of the bottom wall and one or more side walls of the first container.

8. The multi-functional container of claim 7, wherein the bag holder is configured to removably couple to the bottom wall.

9. The multi-functional container of claim 7, wherein the first container comprises one or more coupling elements extending from the bottom wall and defining a slot for receiving the one or more coupling structures of the bag holder.

10. The multi-functional container of claim 7, wherein the one or more side walls of the first container comprises a container coupling element configured to removably couple the first container to a juvenile wheeled carrier.

11. The multi-functional container of claim 7, wherein the first void of the first container is sized to receive a cup.

12. The multi-functional container of claim of claim 7, wherein the bag holder comprises a body having a first side wall at a first side and a second side wall at a second side, wherein at least one of the first side wall and the second side wall has a coupling structure configured to removably couple the bag holder to the container.

13. The multi-functional container of claim 12, wherein both the first side wall and the second side wall have coupling structures configured to removably couple the bag holder to the container.

14. A bag holder comprising:
a first structure comprising a body having a first side wall at a first side and a second side wall at a second side, the first side wall and the second side wall each having an edge extending along a third side, the edge of the first side wall and the edge of the second side wall being spaced apart;
a first coupling element on the edge of the first side wall and a second coupling element on the edge of the second side wall, both the first coupling element and the second coupling element configured to removably couple the bag holder to a second structure comprising a third coupling element and a fourth coupling element and
the body defining a void for holding a plurality of bags and having a bag opening through which one or more bags of the plurality of bags are removed from the void.

15. The bag holder of claim 14, wherein the first coupling structure and the second coupling structure each comprise a hook.

16. The bag holder of claim 14, wherein the first coupling structure and the second coupling structure are each integrally formed with the body.

17. The bag holder of claim 14, further comprising the body having a curved wall at a fourth side joining the first side wall and the second side wall, wherein the bag opening is in the curved wall.

18. The bag holder of claim 17, wherein the body is configured to flex at the curved wall so that the first side wall and the second side wall are capable of being moved closer together.

19. The bag holder of claim 14, wherein the body is a flexible body.

20. The bag holder of claim 14, wherein the bag holder is sized to receive pet waste disposal bags.
